(19) United States
(12) Patent Application Publication
(10) Pub. No.: US 2012/0282568 A1
(43) Pub. Date: Nov. 8, 2012

(54) SELF-REGULATING FLUID DISPENSING CAP SYSTEM AND METHOD OF USE

(76) Inventor: Jimmy D. Disel, Sparks, NV (US)

(21) Appl. No.: 13/466,095

(22) Filed: May 7, 2012

Related U.S. Application Data
(60) Provisional application No. 61/482,921, filed on May 5, 2011.
(60) Provisional application No. 61/482,990, filed on May 5, 2011.

(51) Int. Cl. A61C 17/02

(52) U.S. Cl. 433/80

(57) ABSTRACT

A cap system for connecting a fluid container to a self-contained dental water supply system of a dental work station comprising of a cap that attaches to an open end of a fluid container, a cap holder comprising a manifold and a manifold holder, the manifold connects to the self-contained dental water supply system and to the cap, the manifold moving within the manifold holder when the fluid in the fluid container reaches a certain amount to cause the self-contained dental water supply issue an alarm, the manifold further comprising a gas pressure regulator to convert high pressure gas of the self-contained dental water supply system to low pressure gas to move liquid from the liquid container through the manifold into self-contained dental water supply system, the high pressure gas pushes a sealing plunger in the manifold upon the cap to connect the manifold to fluid container.

### CROSS-REFERENCES TO RELATED APPLICATIONS

This application claims the benefit under 35 U.S.C. §119(e) of U.S. Provisional Patent Application No. 61/482,921, and U.S. Provisional Patent Application No. 61/482,990, both of which were filed on May 5, 2011, contents of which are relied upon and incorporated by reference.

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention relates to cap systems used to reversibly secure and continuously connect fluid containers to self-contained dental water supply systems of dental work stations. More particularity to those cap systems that may be used to monitor the condition of the fluid containers and employ self-adjusting gas pressure systems to power various aspects of the cap system.

### BACKGROUND

One of the growing concerns in the field of dentistry is the continued confirmation of microbial contamination of dental work station waterlines used to deliver water for dental operations. Generally, these waterlines conduct tap water from a continuous water supply (e.g., tap water provided by a municipal water supply) or the like to a dental operation site proximate a dental work station. Research conducted in these matters has generally confirmed the repeated presence of bacteriological pathogens such as Sphyngomonas paucimobilis, Acinetobacter calcoaceticus, Methylobacterium mesophilicum, and Pseudomonas aeruginosa in dental work station waterlines. Forensic pathology has further confirmed cases of transmission of water-based pathogens including that of Legionella pneumophila, the causative agent of legionaries disease, to dental patients and dental healthcare professionals (dental operators) thorough these contaminated dental waterlines. One current theory regarding this kind of contamination is that the small bore of water supply lines or conduits allows a biofilm to form upon the interior surface of the water lines despite the continuous water source (e.g., tap water) being chlorinated. As such, these dental station waterlines (continuous water source) could be considered a potential aquatic ecosystem in which opportunistic pathogens can successfully colonize synthetic waterline surfaces to the point of providing a potentially dangerous concentration level of the pathogens in supplied water directly supplied to the dental patient or indirectly to dental healthcare professional (e.g., supply water being aerosolized during dental operations.)

Presently, there is a movement within the dental field to move away from a continuous water supply source to a generally self-contained dental water supply system that is no longer directly connected to an outside, continuous tap water source. The self-contained dental water supply system may be integrated into a dental work station and may use removable fluid containers to hold distilled water for supplying water in dental operations. These fluid containers are regularly changed out and replenished with water depending on the amount of dental operations being scheduled for that dental work station.

One of the possible difficulties encountered with self-contained dental water supply systems could be system contamination by dental operators in changing out the fluid containers. Many current self-contained dental water supply systems may require the dental operator to manually disconnect (e.g., unscrew) the fluid container from the dental self-contained water supply system and withdraw the fluid container from a fluid pickup tube used by the system to remove fluid from the fluid container. Due to the general awkwardness of this removal process, the dental operator could come into contact with the pickup tube and otherwise cause its contamination, potentially leading to further contamination of the remaining water supply system.

Another problem could be that such self-contained dental water systems may rely upon the dental operator's continual observation of the water system with resulting dental operator's intervention for the system to operate properly. The water system may require the dental operator to visually determine when the fluid container is nearly empty through system operations, to stop dental activities and then replace the spent fluid container with a filled one. Such operations may require the dental operator to carefully watch the water supply system as well as operate on a dental patient.

Another problem may be that the current self-contained dental water supply systems may require that the dental operatives have to continually regulate the operations of these water systems (e.g., adjusting the air pressure running the water system) to effect necessary adjustments in water delivery during dental operations. Sometimes, the dental operative's adjustments lead to the over pressurization of the water system resulting in water leakage from the fluid container (e.g., spraying water over the dental work space) or worse.

What is needed therefore may be a cap system for self-contained dental water supply and methodology of use wherein the cap not only secures to and generally seals the fluid container/pickup tube from contamination, it may also provides the fluid container with quick-connected interface that easily and reversibly connects the container with the dental work station's self-contained dental water supply system. This cap system could further provide a capacity to provide one or more simple, operator-free, self-regulating features such as providing automatic adjustment and control of the pneumatic pressurization of fluid container, automatic locking of the cap/fluid container to the system, sensing fluid level in the fluid container to allow the self-contained dental water supply system to notify the dental operator accordingly.

### SUMMARY OF ONE EMBODIMENT OF THE INVENTION

### Advantages of One or More Embodiments of the Present Invention

The various embodiments of the present invention may, but do not necessarily, achieve one or more of the following advantages:

to provide a cap system that could generally seal a fluid container with a fluid pickup tube from contamination and provide a quick release attachment for the fluid container to its respective self-contained dental water supply system;

the ability to automate the control and adjustment of the pressure of the gas supplied to fluid container used to move fluid out of the fluid container for a self-contained dental water supply system;

provide a cap system that automatically seals the cap-fluid container combination to its respective self-contained dental water supply system;

the ability to protect the fluid pickup tube of a dental water supply fluid container from outside environmental contamination;

provide a cap system that automatically unseals the cap-fluid container combination to a self-contained dental water supply system;

the ability of a cap system to sense the weight of fluid in a fluid container that it is attached to allow its respective self-contained dental water supply system to alert the dental operator when the fluid has reached a certain level in the fluid container;

provide a cap system for a self-contained dental water supply system to free the dental operative of the need for constant visual inspection of the fluid container;

the ability cap system to negate influence of the weight of the fluid container and sense the weight of the fluid container fluid to allow the self-contained dental water supply system informed the dental operative of the operational status of the fluid container; and

the ability to use the weight of the container along with its contents or lack there of to allow to allow a self-contained water supply system of a dental work station to autonomously control the purging of a fluid container as used by the system.

These and other advantages may be realized by reference to the remaining portions of the specification, claims, and abstract.

### Brief Description of One Embodiment of the Present Invention

One possible embodiment of the invention could be a cap system for connecting a fluid container to a self-contained dental water supply of a dental work station comprising of a cap that attaches to an open end of a fluid container to reversibly and continuously connect the interior of the fluid container to a cap holder; the cap holder comprising a manifold and a manifold holder, the manifold being movably received within manifold holder to connect to the self-contained water supply, the manifold further reversibly attaches to the cap to reversibly connect the interior of the fluid container with the manifold, the manifold further having a weight pressure switch that is also connected to the self-contained dental water supply system; wherein the cap holder is adjusted to the presence of a certain amount of fluid in the fluid container that with together with the cap and its attached fluid container will move the manifold relative to the manifold body, this movement will cause the weight pressure switch to contact the manifold holder, the weight pressure switch in response to this contact causes the self-contained dental water supply system to issue an alert regarding the status of fluid within the fluid container.

A cap system for attaching a fluid container to a self-contained water supply system for a dental work station comprising of a cap that attaches to an open end of a fluid container to reversibly and continuously connect the interior of the fluid container to a cap holder; the cap holder comprising a manifold and a manifold holder, the manifold being both received within manifold holder and connected to the self-contained water supply system, the manifold further comprising of an gas pressure regulator and an open-end cavity, the gas regulator generating low pressure gas from high pressure gas as supplied to the manifold by a self-contained dental water supply system; wherein the manifold further directs the high pressure gas into the open-ended cavity to move a sealing plunger to both secure to the cap to the manifold and to reversibly connect to the manifold to interior of the fluid container, this connection allows the low pressure gas to pass through the sealing plunger and enter the interior of the fluid container, the low pressure gas presence in the fluid container then causes the fluid present in the fluid container to move out of the fluid container and through the manifold to enter the self-contained dental water supply system.

process for operating a cap system comprising of providing a cap attached to a fluid container containing fluid, the cap capable of continuously connecting an interior of the fluid container top a cap holder, the cap being received with a cap holder; providing a cap holder, the cap holder comprising of a manifold movably contained within a manifold holder, the manifold further comprising of a body containing gas pressure switch, an open-end cavity movably hold a sealing plunger; and an weight pressure switch; providing a self-contained dental water supply system for supplying water to a, dental work station and for generating high pressure gas, the self-contained dental water supply system further connecting to the manifold; proving high pressure gas to manifold and directing some the high pressure gas to the open-ended cavity to set the sealing plunger upon the cap to continuously connect the manifold to the interior of the fluid container converting high pressure gas to low pressure gas and directing the low pressure gas though the sealing plunger into the interior of the glass container; and directing any fluid in the fluid container out of the fluid container and through the sealing plunger to exit the manifold to be received by the self-contained dental water supply system.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a perspective view of one embodiment of invention showing the invention with the self-contained dental water supply system of the dental work station of the present invention.

FIG. 2 is substantially a cutaway elevation view of one embodiment of the cap system of the present invention.

FIG. 3 is substantially a cutaway perspective view of one embodiment of the cap/fluid container combination of the present invention.

FIG. 4 is substantially a cutaway perspective view of one embodiment of the manifold of the present invention.

FIG. 5 is substantially a cutaway perspective view of one embodiment of manifold holder of the present invention.

FIG. 6 is substantially a cutaway perspective view of one embodiment of sealing plunger and biasing spring of the present invention.

FIG. 7 is substantially a flowchart showing possible process or method for operating the invention.

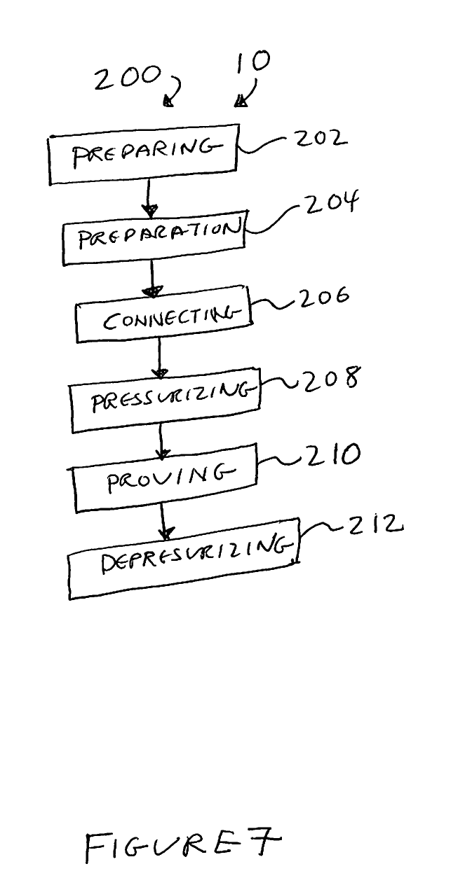

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

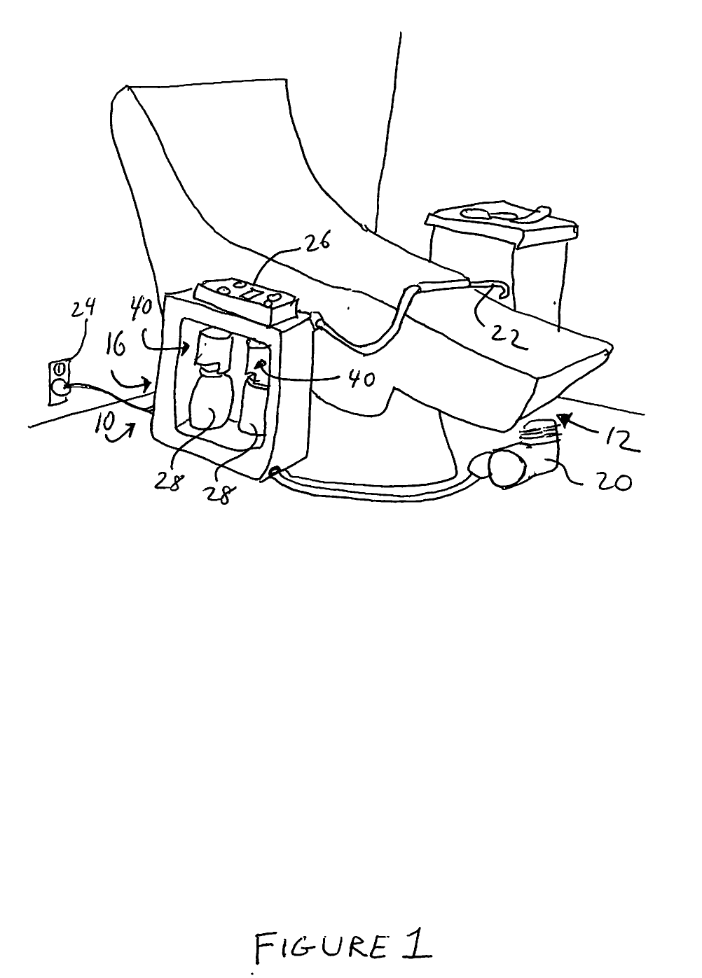

The present invention 10 could comprise of cap system 40 for sealing fluid containers 200 used in self-contained dental water supply systems 16 of a dental work station 12 and a corresponding method of use 100. As substantially shown in FIG. 1, the self-contained dental water supply system 16 could be integrated with a dental work station 12 (e.g., dental chair 14 supporting one or more powered dental implements [not shown]). The self-contained water supply 16 could have access to a electrical power supply 24 powering a electronic control unit 26 (generally operating using integrated circuitry [not shown]) being connected to an array of actuators, sensors, dental operator alert/indictors (e.g., lights, LEDs, sound generators), dental operator adjusted controls, and like for controlling the attachment of the cap system 40 to cap 42/fluid container combination to the self-contained water supply system 16, a pneumatic power supply 20 for generating high pressure gas to transmit fluid from the fluid containers 28 to water delivery devices 22 for the dental work station.

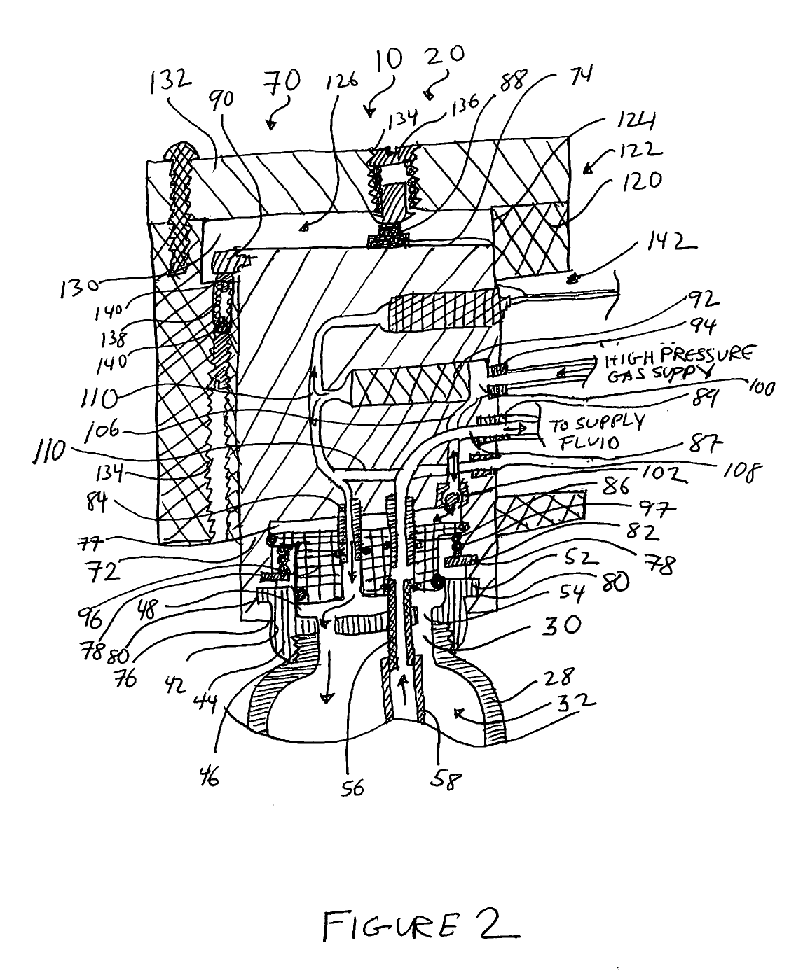

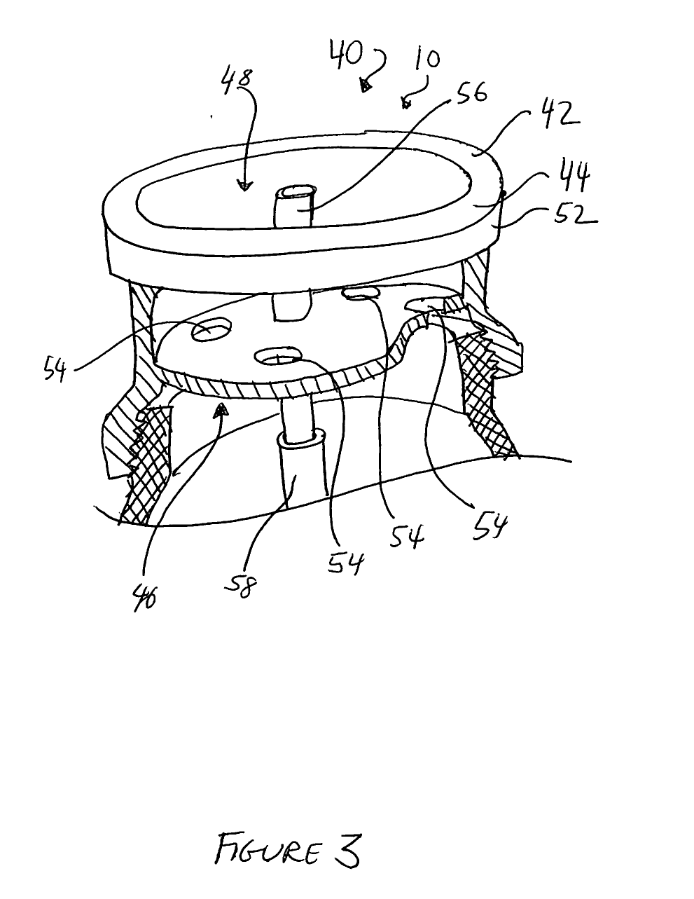

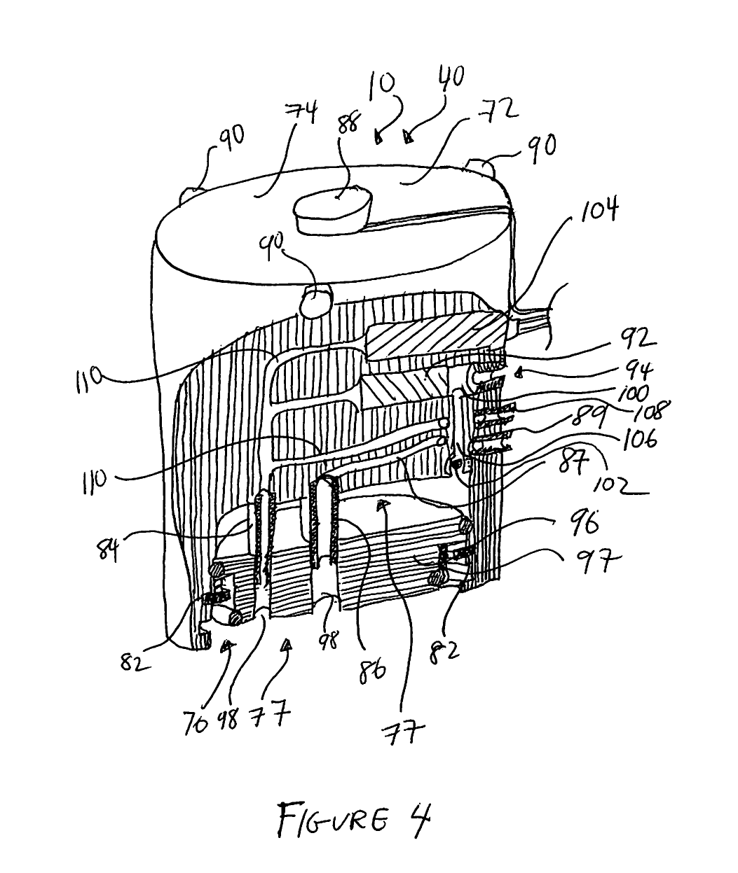

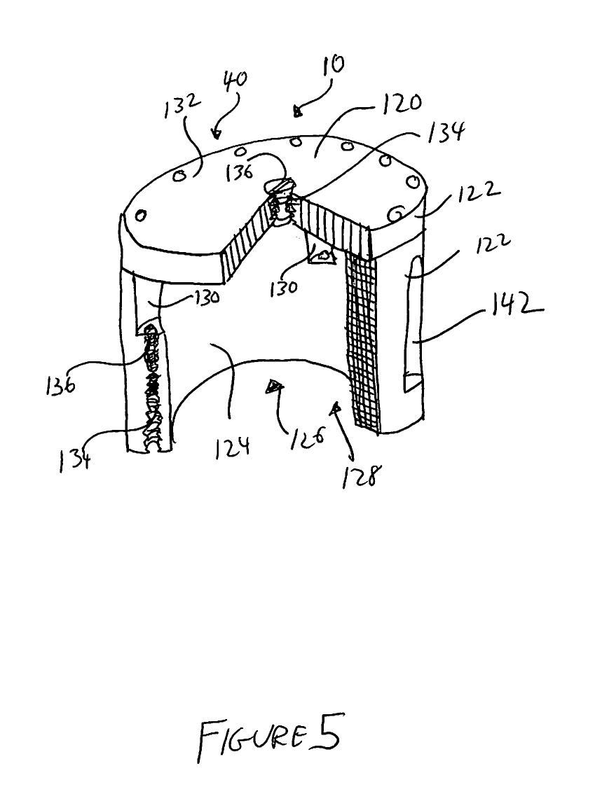

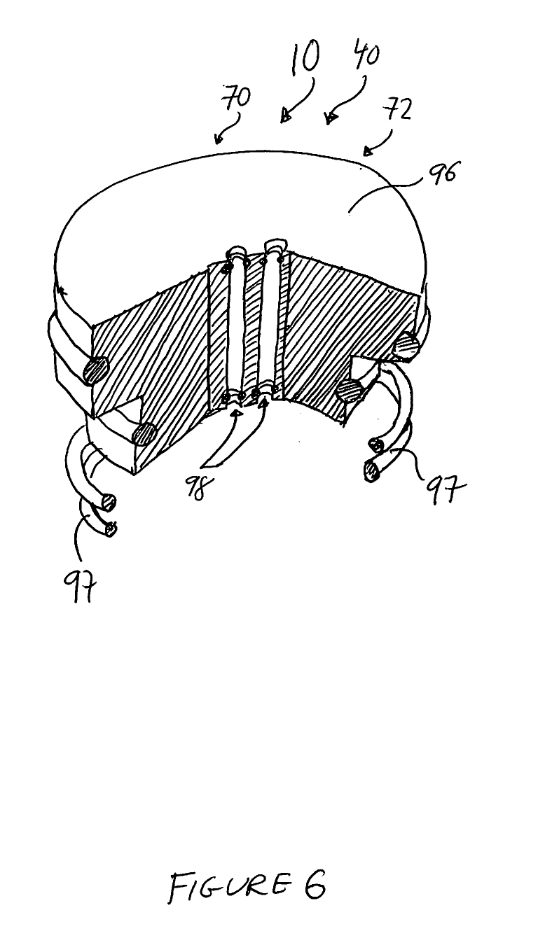

As generally shown in FIGS. 2, 3, 4, 5, and 6, the cap system 40 could comprise of a cap 42 and a cap holder 70, that cap 42 reversibly attaching to and generally sealing a fluid container 28 and fluid container's respective pickup tube 58. The cap 42 could be further capable of reversibly quick-attaching to the cap holder 70 to reversibly connect the interior 32 of the fluid container 28 to the self-contained dental water supply system 16.

The cap 40 could comprise of a cylindrically-shaped cap body 42 having a container end 44 and a holder end 46. The container end 44 could be recessed with a connection capability (e.g., being threaded along its inside wall to reversibly engage the threads of the open end 30 of the fluid container) to reversibly attach to and generally seal a threaded open end 30 of the fluid container 28. The outside wall of the cap 42 by the holder end 46 could support a collar 52 that could be received within a second ring groove 80 of a manifold 72 to reversibly hold the cap 42 within a bottom manifold end 76 of the manifold 72. The holder end 48 could also be similar recessed to reversibly receive a smaller diameter portion of the sealing plunger 96 of the cap holder 70, the plunger 96 generally continuously connecting the top of cap 42/interior of the attached liquid container 28 to the self-contained water system 16. The cap 42 could have one or more low pressure apertures 54 passing through the cap body 44 to directly connect the recess of the container end 46 to that of the holder end 48. A double-opened, hollow liquid tube 56 could passes through the radial axial center of the cap 42 and is barbed on container end 46 to receive and hold a liquid pickup tube 58 that goes into hollow interior of the fluid container 28. Although the fluid containers 28 could be of a multitude of sizes and shapes, their open end 30 is generally sized and configured to allow proper attachment of the fluid container 28 to the cap 42.

In one possible embodiment, the cap holder 70 could be comprised of a manifold 72 and a manifold holder 120. The manifold 72 generally reversibly and securely connects and seals the cap 44 (e.g., cap/liquid container combination) to the rest of the fluid and gas lines of the self-contained dental water supply system 16; may further provide for self-regulation of gas pressure used to move fluid out from the cap/attached fluid container combination as well as locking/sealing the cap/fluid container to the manifold 72; and act as a sensor for the amount of fluid in the fluid container 28 as well as 72 to allow the self-contained dental water supply system 16 to notify the dental operator as to the status of level or amount of fluid in the respective fluid container. The manifold holder 120 could have general configuration of a cylindrical tube with a hollow interior 126 connected to at least one open end 128. The manifold holder 120 could further receive the manifold 72 so that manifold 72 moves like a piston within the hollow interior 128 to project out the one open end 128 to allow the cap holder 70 to use the weight the contents or lack of contents of the of an cap 42/attached fluid container 28 combination to generally monitor and influence the pressuring/draining of the fluid container 28 by the self-contained dental water supply system 16.

The manifold 72 could be comprised of a generally cylindrical-shaped manifold body 74, a sealing plunger 96, a check/reduction valve 102, a weight pressure electrical switch 88 (e.g., an open momentary switch), a gas pressure regulator 92, and a gas pressure electrical switch 104. The manifold body 74 could have a top manifold end 74 and a bottom manifold end 76, wherein the bottom manifold end 76 could be recessed into an open-ended cavity 77 that may movably receive the plunger 96. The walls of the recess of the bottom manifold end 76 could have a first ring groove 78 and a second ring groove 80, the ring grooves being spaced apart in parallel orientation. The first ring groove 78 could receive a C-spring clip 82 to movably retain the sealing plunger 96 and its biasing spring 97 within the bottom manifold end 76. The second ring groove 78 could intercept an cutout 79 that is on the rim of the bottom manifold end 76, which allows the cap 42 to loaded sideways into the recess of bottom manifold end 76 and allows the first ring groove to reversibly seat a portion of the cap's collar 52 to hold the cap/fluid container combination to the manifold 72.

The bottom manifold end 76 could further support a hollow, double open-ended manifold fluid tube 84 and a hollow, open-ended gas tube that descend downward from ceiling of the open-ended cavity 77 to allow controlled connection of self-contained dental water supply system's gas and fluid supplies to cap/fluid container combination. The two tubes 84, 86 generally pass into a set of tube channels 98 in the plunger 96, allowing the plunger to move and extend a connection between the manifold gas tube 84and one or more low pressure gas aperture 54 as well as extend a connection between the manifold liquid tube 86 and the cap liquid tube 56

A fluid channel 87 passing through the manifold body 72 could continuously connect the manifold liquid tube 86 to a fluid outlet 89 located on the side of the manifold body 72. The fluid outlet may be connected to a fluid supply line (e.g., water) of the self-contained dental water supply system 12 to be directed to the water delivery ends 22.

A high pressure bore 100 in the manifold 72 may connect an high pressure gas inlet 94 on the side of the manifold body 72 to a gas pressure regulator 92 retained within the bore. Gas (e.g., air) coming from a high pressure (60-80 PSI) gas supply (e.g., pressurized air from an air compressor-not shown) comes into the bore to enter one end of the gas pressure regulator. The air regulator could be of a type C-1844, mini, fixed at 35 PSI in-line gas regulator available from Parts Warehouse, 211 Grover Street, Lynden Wash. USA 98264. The gas regulator 92 reduces the pressure of the gas passing through it in this operation direction down to 35 PSI). Created low pressure gas (e.g., 45-50 PSI which is much more suitable to pressurizing the fluid containers 28 than then higher pressures of 60-80) then passes the low pressure gas onto an a low pressure bore 108 that connects the other end of the gas pressure regulator 92 to the gas pressure electrical switch 104, the manifold gas tube 84, and a low pressure outlet 108 (located on the side of the manifold body 72.) In one embodiment, the low pressure gas bore 110 could further connect to a pressure relief valve (not shown) (to prevent unwanted build up of high pressure) that vents to the side of the manifold 72.

A high pressure vent bore could generally continuously connect the high pressure gas inlet 94/high pressure gas bore 100 to the reduction/check valve 102 (that could be selected on the basis of one having ordinary skill in that art) that opens on and vents from the ceiling of the open-ended cavity 77. The high pressure gas freely passes through the reduction/check vale to enter the open-ended cavity 77 where it pushes the sealing plunger 96 away from the ceiling unto the cap's holder end 98 so the narrow diameter portion of the sealing plunger 96 seats upon the cap 42 to respectively continuously connect the manifold gas tube 86 to at least one low pressure aperture 59 of the cap 42 and respectively continuously connect the manifold fluid tube 84 to cap fluid tube 56.

The gas pressure switch 104 is located within the manifold 42 to present its electrical connection on the sidewall of the manifold 72 while having its other pressure sensing side open to a low pressure bore 106. As the low pressure gas emanates from the gas pressure regulator 92 through the bore 106, to pressurize the switch 104 to close its electrical contacts to direct power from the electrical power supply 24 to energize the electronic control unit 26. In this manner, the electronic control unit 26 is activated only when the manifold 42 is gas pressurized and is alternately turned off when the manifold 42 is depressurized (e.g., when the pressurized gas supply 20 of the self-contained dental water supply system 16 is turned on or off/vented.) Low pressure gas can further be bled off through the low pressure gas outlet 108 to power pressure gauges, other caps, or devices continuously connected to the low pressure gas outlet 108.

When the high pressure gas is no longer being supplied to the manifold 72 or otherwise being vented away from the manifold 72, the low pressure gas can be vented away from the cap/fluid container combination and gas pressure electrical switch 104 to pass through the gas pressure regulator 92 (or alternatively through the low pressure gas outlet 108) in a controlled manner (the gas pressure regulator 92 presenting resistance to the passage of the low pressure gas through it in that direction) with the low pressure gas ultimately venting out through high pressure gas inlet 94.

At the same time, the high pressurized gas in the open-ended cavity 77 slowly bleeds past the check/reduction valve 102 to vent back out high pressure gas vent bore 106 and through high pressure gas inlet 94. This controlled bleed off slows the movement of sealing plunger by the bias spring 97 and the low pressurized gas (inside the respective fluid container 28 and moving back though the low pressure gas apertures 54) to push the sealing plunger 96 back into the open-ended cavity 77 towards the cavity's ceiling. The controlled movement of the plunger 96 it recede within the open-end cavity 77 prevents a sudden depressurization of the fluid container, which could result otherwise cause a subsequent and violent ejection of any fluid within it. The plunger 96 as it moves it free of contact of the holder end's recess and the cap fluid tube 56 allows a sideways withdrawal of the cap/attached fluid container combination from the manifold 72.

The top manifold end 74 generally supports the weight pressure switch 88 and a plurality of spaced apart studs 90 projecting outward along manifold sidewall along the rim of the top manifold end 74. The studs 90 may individual movably engage respective open-topped channels 130 of interior wall 126 of the manifold holder 120 to substantial direct and control the motion of the manifold 72 as it rides substantially within manifold holder interior 126 like a piston and to generally retain the manifold 72 proximate to the manifold holder 120.

The weight pressure switch 88, when it is not in contact with the undersign of the holder cover 132 (indicating that the engaged fluid container is appropriately filled with fluid and pulling the manifold 72 downward away from the holder cover 132) may, in one embodiment, close an electrical circuit of the electronic controller unit 26 (e.g., circuit board[s] of the dental work station 16) allowing it to detect the status of the fluid container 28 and notify the dental operation in relation to the status of the operation of the self-contained water supply system. (e.g., if the fluid container 28 is empty of water, the switch 88 closed a circuit that through the electronic controller unit 26 could activate an indicator to inform the dental operator of the need to change out the empty fluid container 28.)

The plunger 96 could be shaped like a disk stacked upon a larger diameter disk with edges of each disk supporting a respective O-ring making a movable, sealing contact with the sidewall of the open-ended cavity 77 during the plunger's movement relative to the open-ended cavity 77. The plunger's movement within the open-ended cavity 77 could ensure that tube channels 98 that are continuously connected to and moveably receive both the manifold fluid tube 86 and manifold gas tube 84. The smaller diameter portion of plunger 96 could be positioned with the center of an expanding coil spring that generally biases the plunger towards the ceiling of the open-ended cavity 77.

As the plunger 96 is moved by high pressure gas into contact with the cap 42, the smaller diameter portions seats and seals within the cap 42. One of the tube channels 98 descend upon the cap fluid tube 56, it creates a continuous connection between the manifold fluid tube 86 to the cap fluid tube 56. The seating of the plunger 96 creates a generally sealed air space between the bottom of the sealing plunger and the end cap recess so that the tube channel 98 attached to the manifold gas tube 84 can then direct low pressure gas toward the one or more low pressure gas apertures 54 of the cap 42 and on into the interior 32 of the attached liquid container 28.

The manifold holder 120 could be comprised of a hollow, double, opened-end cylindrically-shaped holder body 122 capped at one open end by a disk-shaped holder cover 132. The holder cover 132 could be penetrated along its edge by fasteners that continue to penetrate through the rim of one of the open ends to connect the holder cover 132 to the holder body 122 encapsulate one of the open ends and generally movably contain the manifold 72 proximate to the holder body.

The radial center of the holder cover 132 can be penetrated by a threaded channel 134 in which is movably lodged the adjustment mechanism 136 (e.g., a coil spring 138 sandwiched between two switch plungers 140) for changing the sensitivity of the weight pressure switch 88. A threaded fastener prevents the adjustment mechanism 136 from backing out through the top of the holder cover 132 as one of the switch plungers 140 makes contact with the weight pressure switch 88 on the top manifold end 74. The adjustment of the placement of the threaded fastener relative to the adjustment mechanism 136 can be used to set the sensitivity of the self-contained dental water supply system 16 as to the amount of fluid in the fluid container 28. For example, when the water drops to a certain level, the weight pressure switch act upon an electrical circuit of the electronic control unit 26 to result in an activation of indicator to inform the dental operator of the status of the water in the fluid container 28.

The holder body 122 could have at the open end that is enclosed by the holder cover 132 a set of spaced apart open-top channels 130 whose sides also open onto the interior wall 124 of the holder body 122. Each of these open-topped channels 130 could movably receive a respective stud 90 from the manifold 72 as it is movably placed within the interior 126 of the manifold holder 120. The bottom of each of these open-topped channels 130 could be respectively connected to threaded channel 134 in which an adjustment mechanism 136 is placed to act against the stud 90 riding in the open topped channel 130. By moving the threaded fastener to adjust the tension provided by the respective adjustment mechanisms in the holder body's threaded channels 134, the cap system 40 could be adjusted to compensate for the empty weight of the respective fluid container 28 in relation to the triggering of the weight pressure switch 88.

The holder body 122 could be penetrated by a vertical channel 142 that connects the body's interior wall 124 to the body's exterior wall. The vertical channel 142 could allow and fluid line, gas lines, and electrical wiring of the self-contained dental water supply system 26 to pass through the side of the holder body 122 to the contact the sidewall of the manifold 72 to respectively connect to the fluid outlet 89, high pressure gas inlet 94 and low pressure outlet 108, and gas pressure electrical switch's electrical contacts. The length of the vertical channel 142 should be sufficient enough to allow the free movement of the manifold 72, within the manifold holder 120, as connected to the water system's wiring, gas lines and liquid lines.

As generally shown in FIG. 1, one possible embodiment of the method of use 200 for the cap system 40 could start with step 202, preparing the fluid container. In this step, the dental operator could select the fluid container by size and shape and accordingly select the appropriated length of pickup tube. One end of the selected pickup tube could then be continuously attached to the end of the fluid tube on the container end of the cap. With general placement of the cap fluid tube within the interior of the fluid container, the cap could be appropriately be attached to open end of the fluid container, effectively sealing the fluid container and protecting the pickup tube from general outside contamination. At this time, the completed fluid container would be ready for attachment to a dental water supply filling station and appropriately filled with water (or disinfectant as required) by filling station. At the substantial completion of this step, the process 200 could proceed to step 204, preparation of cap holder.

At step 204, preparation of cap holder, the dental operator could make adjustments to the adjustment mechanism(s) for cap holder body (e.g., coarse adjustment) to take into account the empty weight of selected fluid container for the self-contained dental water supply system. The dental operator could then make subsequent adjustments to the adjustment mechanism for the weight pressure switch (e.g. the fine control or adjustment) regarding its sensitivity to react to a specific weight (e.g., amount) of fluid (or lack there of) in the fluid container. Once this step is substantially completed, the process 200 could proceed to step 206, connecting cap/fluid container combination with cap holder.

In step 206, connecting cap/fluid container combination with cap holder, the operator can move the cap/fluid container combination so that the cap moves sideways through the cutout on the bottom holder end into the open-ended cavity (the bias spring keeping the sealing plunger up into the cavity) so that the cap's collar can at least partially engage the second ring groove. Once this step is substantially completed, the process 200 could generally proceed to step 208, pressurizing the system.

In step 208, pressurizing the system, the air pressure system is activated so that high pressure gas (e.g., 60-80 PSI) flows to the high pressure inlet into the high pressure bore to flow through the gas pressure regulator to become low pressure gas (e.g., 40-50 PSI). A bleed off through the high pressure vent freely passes through the check/resistance valve to enter the open ended cavity to push the sealing plunger against its biasing spring. The high pressure gas firmly seats/seals the smaller diameter portion for the sealing plunger into the recess of the container end of the cap. The combined weight of the cap/attached filled fluid container also moves the manifold against the adjustment mechanisms in the body of the manifold holder as the manifold moves downward in the manifold holder and away from bottom of the manifold holder cover.

A tube channel descends down upon and receives the end of cap fluid tube to continuously link the pick up tube and the fluid in the interior of the fluid container tube. The other channel tube is brought down proximate to the low pressure apertures within the cap recess to continuously link the low pressure bore, the manifold gas tube, the channel tube, the low pressure aperture and interior of the fluid container.

As the low pressure gas passes into the low pressure bore from the gas pressure regulator, the low pressure gas activates the gas pressure electrical switch to complete the electrical circuit to power the electronic control unit. The low pressure gas moves then through the manifold to the attached fluid container to pressurize the attached filled fluid container. The low pressure gas may move out through the low pressure gas outlet to power devices outside the manifold (pressure gauge, other cap systems, and the like.) As this step is substantially completed, the process 200 could proceed to step 210 providing fluid.

In step 210, providing fluid, the dental operator activates the water delivery ends at the dental work station. These actions substantially allows the low pressure gas in the attached fluid container to push the fluid into the cap pick up tube, through the fluid tube, into the manifold fluid channel, out the fluid outlet and into the fluid supply line of the self-contained dental water supply system. As the dental operative keeps using the water supply system in dental operations (or conversely using disinfectant supplied by the invention to clean the water supply system), the fluid in the attached fluid container is consumed, reducing the combined weight of the container and its fluid. At the point the fluid level has reached a set triggering point with the attached fluid container, the previously adjusted cap holder (i.e., manifold and its holder) will allow the manifold to move up towards the holder cover so that the weight pressure switch can be active by contact with the underside of the holder cover. The activated weight pressure switch may complete an electrical circuit within the water supply system (e.g., the electronic controller unit) whereby an indicator is activated to notify the dental operative that the fluid level in the attached fluid container is low and the container needs to be exchanged for a filled fluid container. As this step is substantially completed, the process 200 could proceed to the next step 212, depressurizing the cap system.

In step 212, depressurizing the cap system, the dental operator in being notified by the system that the fluid level of the attached fluid container is low and needs to be changed out can turn off (e.g., set to vent) the high pressure gas system of the self-contained dental water supply system. When the high pressure gas is no longer entering the high pressure gas outlet, the high pressure gas in the open-ended cavity of the manifold can moves from the open-ended cavity into the high pressure gas vent as it slowly moves through the check/resistance valve. The valve slows the movement through it to prevent a sudden lifting by the sealing plunger causing and unwanted immediate decompression of the attached fluid container. As the high pressure gas evacuates, the biased spring pushes the sealing plunger towards the ceiling of the open ended cavity and off of the cap. At the same time, the low pressure gas moves through the gas pressure regulation in a slower and reverse process to evacuate the low pressure bore. As the low pressure gas evacuates, the gas pressure switch turns off and cuts the power to the electronic control unit. The time for this operation to be complete is generally about a second or so depending upon the size of the fluid container. The dental operator can then withdraw the cap/attached fluid container from the cap holder. If the dental operator wishes to place a replacement cap/attached fluid container, the process 200 could proceed to step 206.

### CONCLUSION

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. A cap system for connecting a fluid container to a self-contained dental water supply system of a dental work station comprising:
(A) a cap that attaches to an open end of a fluid container to reversibly and continuously connect to an interior of the fluid container to a cap holder;
(B) the cap holder comprising a manifold and a manifold holder, the manifold being movably received within manifold holder to connect to the self-contained dental water supply system, the manifold further reversibly attaches to the cap to reversibly connect the interior of the fluid container with the manifold, the manifold further having a weight pressure switch that is also connected to the self-contained dental water supply system;
wherein the cap holder is adjusted to the presence of a certain amount of fluid in the fluid container, this certain amount of fluid together with the cap and its attached fluid container will move the manifold relative to the manifold body, this movement will cause the weight pressure switch to contact the manifold holder, the weight pressure switch in response to this contact causes the self-contained dental water supply system to issue an alert regarding the status of fluid within the fluid container.

2. The cap system of claim 1 wherein the manifold holder further has a channel through which the self-contained dental water supply system connects to manifold to allowing movement of the manifold within the manifold holder.

3. The cap system of claim 1 wherein the manifold further comprises of an open-ended cavity that movably contains a sealing plunger, the sealing plunger can move to be seated upon the top of the cap so as to lock the cap within the manifold and to continuously connect the interior of the fluid container to the manifold.

4. The cap system of claim 1 wherein the manifold further comprises a check/resistance valve though which a portion of a high pressure gas as delivered by the self-contained dental water supply system to the manifold passes freely though the check/resistance valve to enter the open-end cavity.

5. The cap system of claim 4 wherein the presence of the high pressure gas in the open-ended cavity pushes a portion of the sealing plunger down upon the cap to connect the cap to the manifold.

6. The cap system of claim 4 wherein the check/resistance valve allows the high pressure gas to pass through it at slower rate when the high pressure gas is leaving the open-ended cavity and exiting the manifold than when high pressure gas passes through the check/resistance valve in entering the open-ended cavity.

7. The cap system of claim 6 wherein the slower rate prevents an unwanted expulsion of the fluid from the fluid container between an opening created between the sealing plunger and cap.

8. The cap system of claim 1 wherein the manifold has an air pressure regulator that creates a low pressure gas from a high pressure gas supplied by the self-contained dental water supply system to the manifold, the low pressure gas passes from the gas pressure regulator to be directed through the sealing plunger and into the interior of the fluid container.

9. The cap system of claim 8 wherein the low pressure gas is the interior of the fluid container moves any liquid present in the fluid container from the fluid container through the sealing plunger into the manifold where liquid can then exit from manifold through a fluid outlet, the fluid outlet being capable of delivering the fluid to the self-contained dental water supply system.

10. The cap system of claim 7 wherein the manifold further comprises a gas pressure electrical switch that is connected to an electronic control unit and a electrical power supply of the self-containing dental water supply system, when low pressure gas activates the gas pressure electrical switch, the gas pressure electrical switch causes a electrical power supply to energize a electronic control unit, and alternatively in the absence of the gas, the gas pressure electrical switch causes the electronic control unit to de-energize.

11. The cap system of claim 7 wherein the manifold further comprises a low pressure gas outlet, the manifold directs low pressure gas to the low pressure gas outlet to allow the a portion of the low pressure gas to be diverted.

12. A cap system for attaching a fluid container to a self-contained water supply system for a dental work station comprising:
(A) a cap that attaches to an open end of a fluid container to reversibly and continuously connect the interior of the fluid container to a cap holder;
(B) the cap holder comprising a manifold and a manifold holder, the manifold being both received within manifold holder and connected to the self-contained water supply system, the manifold further comprising of an gas pressure regulator and an open-end cavity, the gas regulator generating low pressure gas from high pressure gas as supplied to the manifold by a self-contained dental water supply system;
wherein the manifold further directs the high pressure gas into the open-ended cavity to move a sealing plunger to both secure to the cap to the manifold and to reversibly connect to the manifold to interior of the fluid container, this connection allows the low pressure gas to pass through the sealing plunger and enter the interior of the fluid container, the low pressure gas presence in the fluid container then causes the fluid present in the fluid container to move out of the fluid container and through the manifold to enter the self-contained dental water supply system.

13. The cap system of claim 11 wherein the manifold further comprising of a check/resistance valve, the high pressure gas freely passing through the check/resistance valve to enter the open-ended cavity and the check/resistance valve providing resistance to the movement of high pressure gas to slow it's movement through the check resistance valve as the high pressure gas exits the open-ended cavity, the resistance preventing an unwanted expulsion of fluid from the fluid container between an opening created between the sealing plunger and cap by the high pressure gas leaving the open-ended cavity.

14. The cap system of claim 7 wherein the manifold further comprises a gas pressure electrical switch that is connected to an electronic control unit and an electrical power supply of the self-containing dental water supply system, when the manifold directs low pressure gas to the gas pressure electrical switch, the as pressure electrical switch causes the electrical power supply to energize the electronic control unit, the gas pressure electrical switch alternatively in the absence of the low pressure gas, causes the electronic control unit to de-energize.

15. The cap system of claim 11 wherein the manifold further comprises a weight pressure switch electrically connected to the self-contained dental water supply system, the presence of a certain amount of fluid within the fluid container causes the manifold to contact the manifold holder in manner that activates the weight pressure switch.

16. The cap system of claim 15 wherein the activation of the weight pressure switch either opens or closes an electric circuit of the electronic control unit to causes the self-contained dental water supply system a warning on the status on fluid in the fluid container.

17. A process for operating a cap system comprising:
(A) providing a cap attached to a fluid container containing fluid, the cap capable of continuously connecting an interior of the fluid container to a cap holder, the cap being received with a cap holder;
(B) providing a cap holder, the cap holder comprising of a manifold movably contained within a manifold holder, the manifold further comprising of a body containing gas pressure switch, an open-end cavity movably hold a sealing plunger; and an weight pressure switch;
(C) providing a self-contained dental water supply system for supplying water to a dental work station and for generating high pressure gas, the self-contained dental water supply system further connecting to the manifold;
(D) proving high pressure gas to manifold and directing some the high pressure gas to the open-ended cavity to set the sealing plunger upon the cap to continuously connect the manifold to the interior of the fluid container
(E) converting high pressure gas to low pressure gas and directing the low pressure gas though the sealing plunger into the interior of the glass container; and
(F) directing any fluid in the fluid container out of the fluid container and through the sealing plunger to exit the manifold to be received by the self-contained dental water supply system.

18. A process for operating a cap system 17 further comprising the step of moving the manifold relative to the manifold holder when fluid in the fluid container reaches a predetermined amount.

19. A process for operating a cap system of claim 17 wherein the step of moving the manifold relative to the manifold holder further comprises of the step of contacting the weight pressure switch with the manifold holder resulting in the activating the weight pressure switch.

20. A process for operating a cap system of claim 19 wherein the step of activating the weight pressure switch further comprises of the step issuing a notification about the level of fluid in the fluid container.
